(19) United States
(12) Patent Application Publication
(10) Pub. No.: US 2003/0043428 A1
(43) Pub. Date: Mar. 6, 2003

(54) Method and device for optical spectrum analyzer

(76) Inventors: David Lidsky, Sea Bright, NJ (US); Jithamithra Sarathy, Atlantic Highlands, NJ (US)

Correspondence Address: KAPLAN & GILMAN , L.L.P., 900NROUTE 9 NORTH, WOODBRIDGE, NJ, 07095, US

(21) Appl. No.: 10/224,936

(22) Filed: Aug. 21, 2002

Related U.S. Application Data
(60) Provisional application No. 60/313,744, filed on Aug. 21, 2001.
(60) Provisional application No. 60/364,931, filed on Mar. 15, 2002.

(51) Int. Cl. H04B 10/08; H04B 10/06; G03H 1/28

(52) U.S. Cl. 359/110; 359/24; 359/189

(57) ABSTRACT

A method and apparatus are presented for a tunable device for measuring the optical spectrum of a DWDM signal on a per channel basis. The device is an InP-semiconductor based tunable ring resonator. In a preferred embodiment the typical size of the chip is approximately 250μm×250μm. The three main sections of the device comprise a straight input passive waveguide, a straight output absorbing waveguide, and a tunable ring resonator. The ring resonator sets up a wavelength selective resonant cavity, allowing measurement of OP and OSNR across the free spectral range of the device, centered at a nominal service wavelength. In the preferred embodiment, the device can measure the OP and OSNR of an arbitrary demultiplexed DWDM signal, with a measurement time of approximately 225 microseconds. Inasmuch as the device is simply measuring optical performance parameters within a particular frequency (i.e. wavelength) range, the bit rate, format, and any other protocol based or organizational structures are irrelevant to the spectrum analysis. Thus the invention is fully bit-rate and format insensitive, allowing repeated use of the same device throughout the network, including in parallel arrays.

### CROSS REFERENCE

This is a continuation application of the U.S. provisional applications 60/313,744 (filed on Aug. 21, 2001) and 60/364,931 (filed on Mar. 15, 2002).

### TECHNICAL FIELD

This invention relates to telecommunications, and more specifically, to an improved method and apparatus for the monitoring of the performance of optical signals in optical data networks.

### BACKGROUND OF THE INVENTION

Optical communications networks are becoming more and more prevalent. This is because they facilitate high bandwidth long haul connections among nodes in a data network. All “optical networks” currently operating, whether commercially or merely for research purposes, transmit data signals which in actuality are converted from the optical to the electrical domains at some point in the routing, switching, processing or transmission of the data signals. The more that the data signals can be routed, switched, processed and transmitted in the optical domain, the better the overall benefit to system efficiency in terms of conversion losses and throughput potential. Thus the future looms brightly for all optical data networks.

In order to accurately monitor and maintain system performance, such a system must have a means of measuring and monitoring the optical signals managed by it. The system must regularly monitor certain performance parameters of the optical signals to determine overall signal strength, and the information content of these signals. As well, since many optical data network topologies utilize redundancy as a fail-safe and backup strategy, the optical signal is often monitored at the input and output ports of various system components and used as a means to choose which of two redundant components will carry the actual signal.

In light of the above discussion, the Optical Power (OP) and the Optical Signal to Noise Ratio (OSNR) of a given service wavelength are two key Optical Performance Monitoring (OPM) parameters that need to be measured in optical networks. These measurements facilitate service maintenance as well as fault isolation in optical networks.

In order to increase the data traffic that can be carried on a given physical fiber, modern optical communications systems utilize Dense Wave Division Multiplexing, or DWDM. This is a technique whereby many different optical wavelengths, each carrying its own signal, are combined for transport, and are demultiplexed at network nodes for routing and other processing. DWDM has thus become a mainstay technology for multiplying the available bandwidth in optical systems. Current optical communications systems measure the OP and OSNR on the multiplexed signal. This method, which must acquire information from a band-wide signal (such as the currently utilized 1529 nm to 1562 nm wavelength range, known as the “C Band”) takes time. Therefore, the present embodiments of such measurement schemes are slow in speed (typically 100 msec to 2 sec scan time) relative to the data rates. Thus, if failure detection is dependent upon optical performance measurement, much data will be lost before a failure can even be detected. As data rates continue to migrate higher, this effect becomes more and more pronounced. For example, at the OC-768 data rate of 40 Gb/s, 5 Megabytes of data are lost before the failure can even be detected.

Additionally, current OPM devices also use discrete components, and, as a result, the overall device sizes range in centimeters or inches. This size is cumbersome. Further, these OPM devices are incapable of integration with other network nodal circuitry on one chip or substrate, and the results of optical performance measurement are not as immediately available to the control circuitry as they could be if the signal was merely being sent from one part of an integrated device to another.

By utilizing OPM devices that measure across the entire band of the multiplexed signal, a system effectively ties itself to serial processing; one has to wait for the full cycle of supported wavelengths to be measured before a given service wavelength can be measured again. This precludes distributed or parallel processing and thus wastes valuable time. As the number of service wavelengths in DWDM systems continue to increase, the time required for single device multiplexed signal OPM will tend to further increase. Given an accompanying increase in data rates (i.e. to 60 and even 80 Gbit/sec.) more and more data will be doomed to oblivion prior to the fault even being discovered.

What is thus needed is an optical performance measurement device with increased acquisition speed, allowing a more efficient optical characterization of DWDM signals, as well as the possibility of parallel processing of OPM.

What is further needed is an optical performance measurement device that is compact enough to be integrated with other network circuitry, thus increasing the speed of availability of performance information to decision and monitoring circuitry, as well as allowing the fuller integration and miniaturization of optical network node functionalities.

### SUMMARY OF THE INVENTION

A method and apparatus are presented for a tunable device for measuring the optical spectrum of a DWDM signal on a per channel basis. The device is an InP-semiconductor based tunable ring resonator. In a preferred embodiment the typical size of the chip is approximately 250 μm×250 μm. The three main sections of the device comprise a straight input passive waveguide, a straight output absorbing waveguide, and a tunable ring resonator. The ring resonator sets up a wavelength selective resonant cavity. The 3 dB bandwidth of this cavity is approximately 1 GHz. The selected wavelength can be adjusted by injecting current into the ring. The photocurrent from each 1 GHz slice of the spectrum is thus converted into a voltage and the OSNR is calculated therefrom in a simple way. The measured peak power indicates the optical power in the signal.

In such preferred embodiment, the device can measure the OP (optical power) and OSNR of an arbitrary demultiplexed DWDM signal, with a measurement time of approximately 225 microseconds.

Inasmuch as the device is simply measuring optical performance parameters within a particular frequency (i.e. wavelength) range, the bit rate, format, and any other protocol based or organizational structures are irrelevant to the spectrum analysis. Thus the invention is fully bit-rate and format insensitive, allowing repeated use of the same device throughout the network, including in parallel arrays.

### BRIEF DESCRIPTION OF THE DRAWINGS

FIG. 1 depicts a top view of the device of the present invention;

FIG. 2 depicts a cross section of the input waveguide of the device shown in FIG. 1;

FIG. 3 depicts a cross section of the output waveguide of the device shown in FIG. 1;

FIG. 4 depicts a cross section of the tuning ring of the device shown in FIG. 1;

FIG. 5 depicts the signal pathway of the photocurrent obtained according to the present invention;

FIG. 6 depicts the central portion of the bandwidth of the measured signal using the method of the present invention;

FIG. 6A depicts exemplary sample points taken in a typical measurement according to the present invention;

FIG. 6B depicts an exemplary wavelength spectrum measured at one of the exemplary sample points depicted in FIG. 6A;

FIG. 7 depicts an exemplary system utilizing the device of the invention;

FIG. 8 depicts a cross section of the input waveguide of the device according to a second embodiment of the invention;

FIG. 9 depicts a cross section of the output waveguide of the device according to a second embodiment of the invention; and

FIG. 10 depicts a cross section of the tuning ring of the device according to a second embodiment of the invention.

Before one or more embodiments of the invention are explained in detail, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as in any way limiting.

### DETAILED DESCRIPTION OF THE PREFERRED EMBODIMENTS

Device Description

The idea of the invention is a simple one. It is more efficient in terms of time to implement optical performance monitoring (“OPM”) on a demultiplexed single service wavelength of a DWDM optical network. If one device can be constructed that can accomplish OPM on every slice of the service spectrum (or nearly the entire inter service wavelength distance, centered at the nominal service wavelength), the temporal efficiency can be exploited with minimum complexity. As well, such a device facilitates parallel processing, by utilizing multiple devices in an array. Copending U.S. patent application Ser. No. 09/852,582, which is under common assignment herewith and not prior art, discloses such a device, utilizing a linear shifted grating structure. The present invention presents an alternative design, based upon a resonant ring.

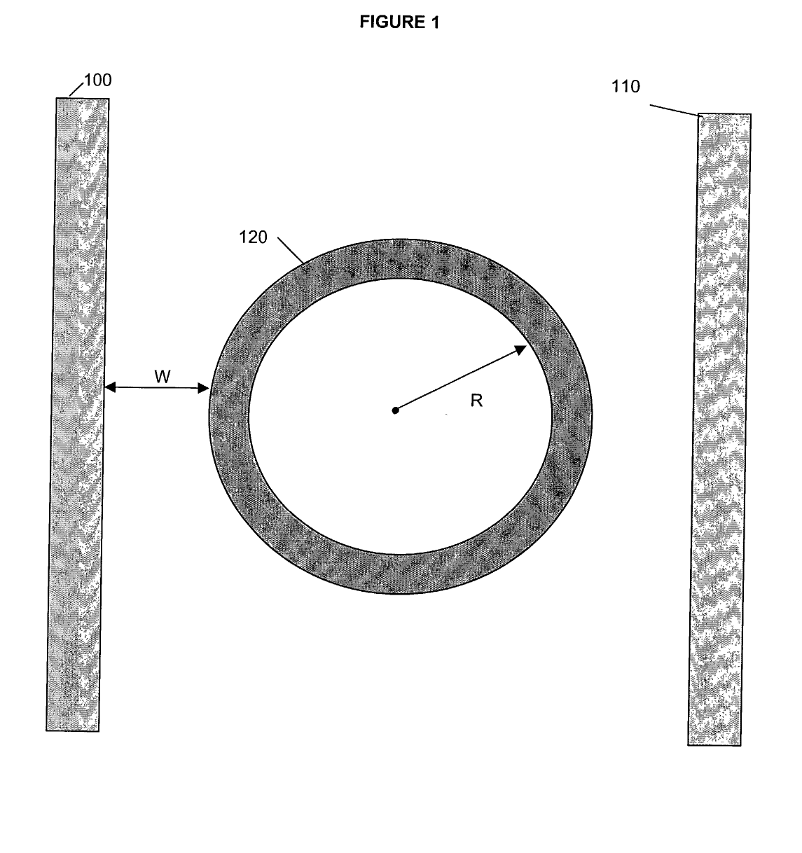

A preferred embodiment of the device of the present invention is depicted in FIG. 1. Such embodiment comprises an input waveguide 110, an output absorption waveguide 120, and a tuning section comprising a ring resonator 130.

There are various design considerations applicable to the structure of FIG. 1. The input waveguide 110 captures a portion of a tapped demultiplexed optical signal. The distance between the input waveguide 100 and the resonant ring 120, depicted as W in FIG. 1, will determine the coupling between them, with a high degree of sensitivity. As this width increases, the coupling decreases, implying a lower power in the signal coupled to the ring, yet with a finer profile, i.e. the signal is less spread out in the frequency domain. On the other hand, decreasing the width does the opposite; there is greater coupling, and thus the signal captured in the ring resonator has more energy. At the same time this signal has a broader spectrum in the frequency domain.

The device's core is the InP-semiconductor based tunable ring resonator 130. The ring resonator 130 sets up a wavelength selective resonant cavity. The 3 dB bandwidth of this cavity is approximately 1 GHz. The selected wavelength can be adjusted by injecting tuning current into the ring. The photocurrent form each 1 GHz slice of the spectrum is converted into a voltage and the OSNR is calculated therefrom in a simple way. The measured peak power indicates the optical power in the signal.

A preferred embodiment of the invention is designed for optical systems capable of supporting 40 Gbit/sec data rates, utilizing a 100 GHz distance between service wavelengths. As data networks migrate to even smaller channel spacing, such as, for example, 50 GHz or even 25 GHz, alternative embodiments of the invention, preserving the structure but modifying the physical device distances may be useful. In general the Free Spectral Range of the tuning ring is inversely proportional to its diameter.

There are two preferred embodiments of the ring resonator structure of FIG. 1. One comprises a buried heterostructure. The other a raised, or ridge waveguide structure. They will be each next described in sucession.

Buried Heterostructure

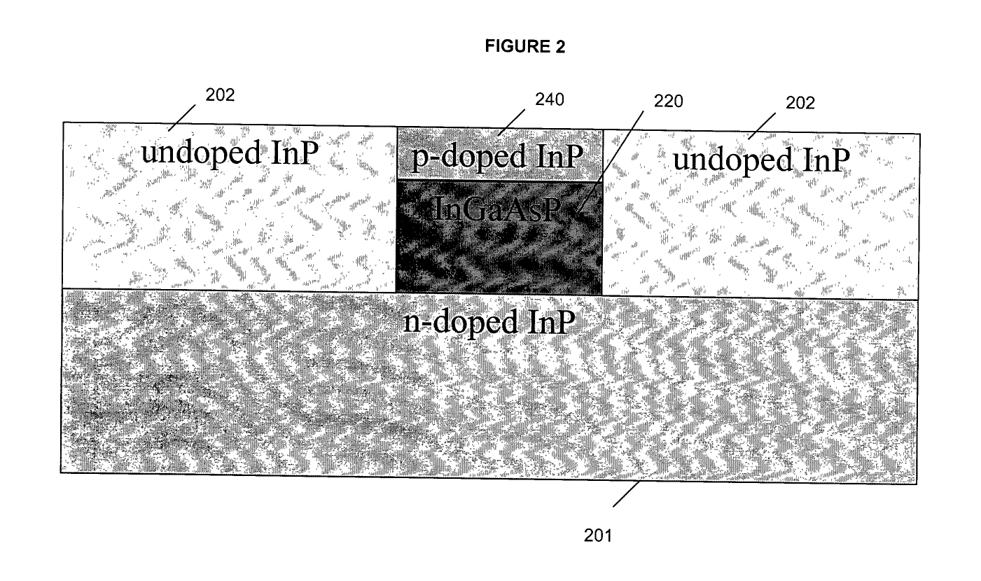

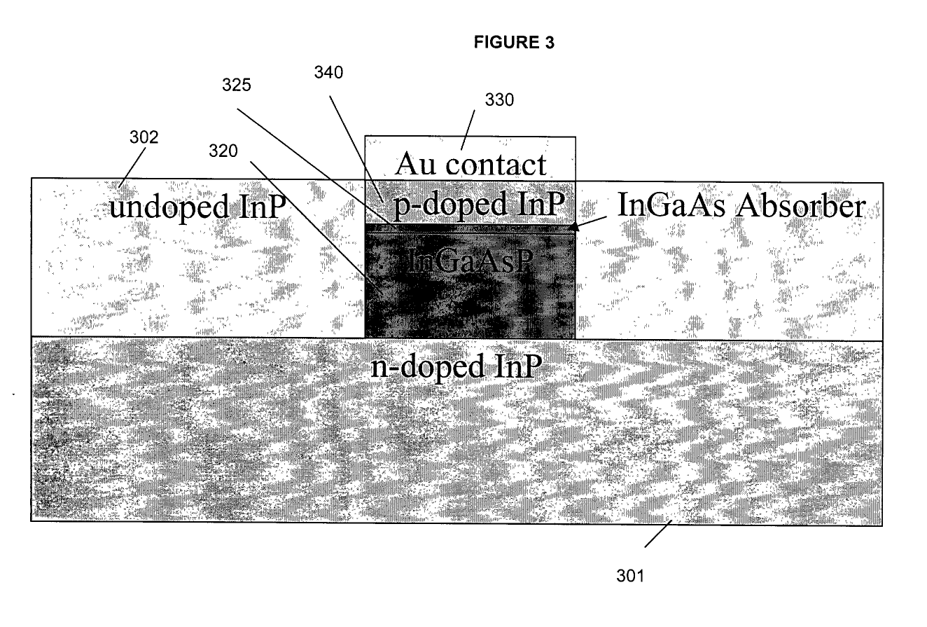

In the buried heterostructure preferred embodiment of the invention the following physical specifications are utilized. The size of the chip is approximately 250 μm×250 μm. The cross sections of each of the input waveguide 100, the tunable ring resonator 130, and the output absorbing waveguide 120, are shown in FIGS. 2, 3 and 4, respectively. In the buried heterostructure embodiment, all three sections are integrated on a common n-doped InP-semiconductor substrate 201, 301 and 401 (with reference to FIGS. 2, 3 and 4, respectively). The width of each waveguide 110, 120 and 130 (with reference to FIG. 1) is 1 micron. The average radius of curvature, R, of the ring is 150 microns, chosen to ensure a Free Spectral Range (“FSR”) of 100 GHz. If a smaller FSR is desired, as may be necessary in the future to support a DWDM system with a smaller inter service wavelength distance, the radius of curvature would need to be increased. In general, the FSR is inversely proportional to the radius R of the resonant ring 120. The air gap between the input waveguide 110 and the curved sections of the resonant ring 120 at the point of closest approach, depicted as W in FIG. 1, is 0.75 microns. The layer heights for the active sections of each of the three waveguide sections are as follows: InGaAsP core 215, 315, 415: 0.45 microns; p-doped InP 216, 316, 416: 0.25 microns. Thus the height of the central section of each of the input and ring waveguides in a preferred embodiment, not including the metal contacts in the ring, is 0.70 microns. In addition to such InGaAsP core and p-doped InP regions, the output waveguide (FIG. 3) has an InGaAs absorber region 317 as well, having a height of 0.08 microns. Thus, the output waveguide is 0.08 microns higher that the input waveguide in this exemplary embodiment.

Ridge Embodiment

The ridge embodiment is characterized by the fact that it can be manufactured in a simpler manner, as will be next described. In one common method, the process of manufacturing the buried heterostructure embodiment of the ring resonator begins with a three layered crystalline material. There is a substrate of InP, a middle quaternary layer, i.e. composed of InGaAsP, and an upper layer of InP. The original material can be visualized with reference to the central portion of FIG. 2, where the substrate 201 is on the bottom, and the quarternary layer 215 on top of it. The upper quaternary layer is selectively etched away in all but the center portion of the structure, to leave the core 215. Then InP crystal is regrown on the sides and top of the central portion 250, to form the undoped InP regions 225 to the right and left of the central portion of the waveguide as well as the p-InP region 216 on top of the core 215. Thus the central portion of the waveguide is in fact “buried.” Crystal regrowth is somewhat complex, and the ridge embodiment obviates the need for this step in the manufacturing process, hence the simplified manufacture.

The ridge waveguide begins with a three layer crystalline structure provided on an InP substrate. The structure comprises a n-doped InP layer, an InGaAsP layer above that, and above that layer, a p-doped layer of InP. The output waveguide has an additional InGaAs absorber layer below the p-doped InP layer.

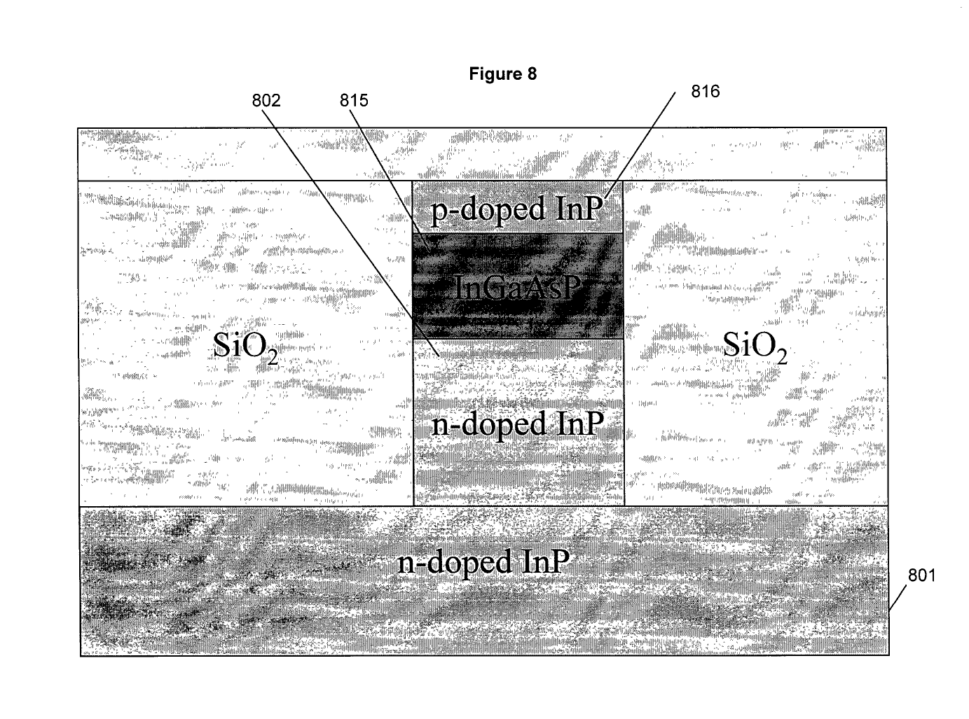

But once the two upper layers have been etched away on the sides of the central portion of the waveguide, the crystal is not regrown. Rather, SiO₂ is simply deposited on the structure, as shown n FIGS. 8-10.

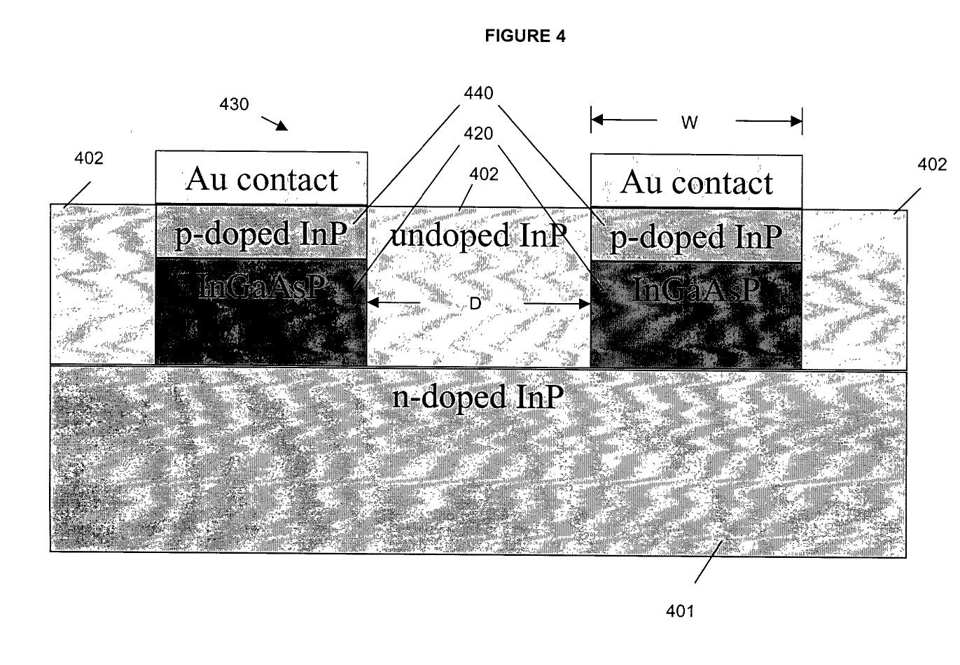

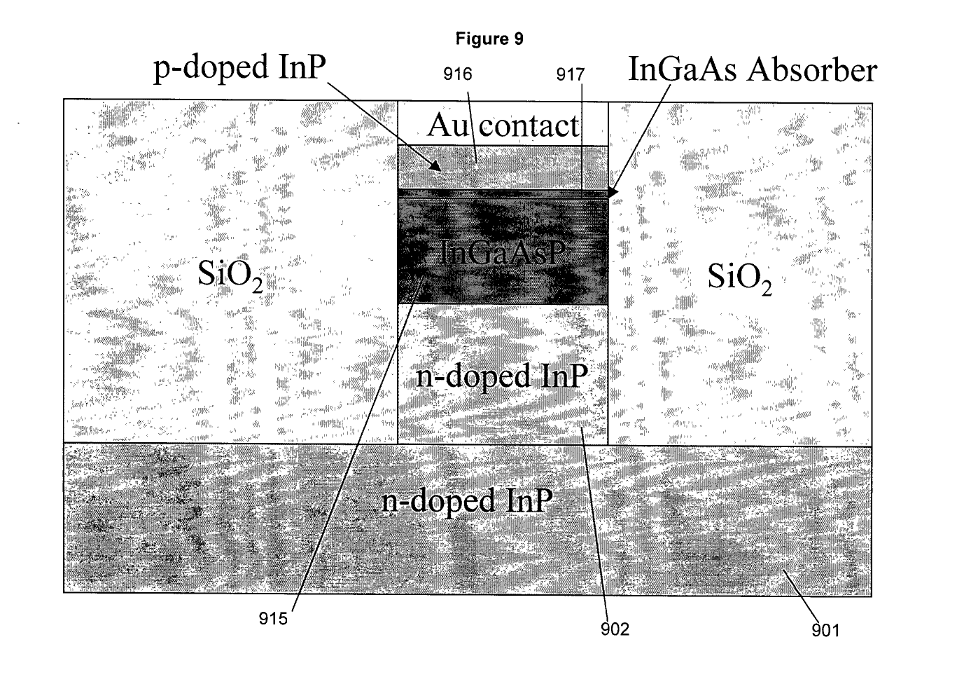

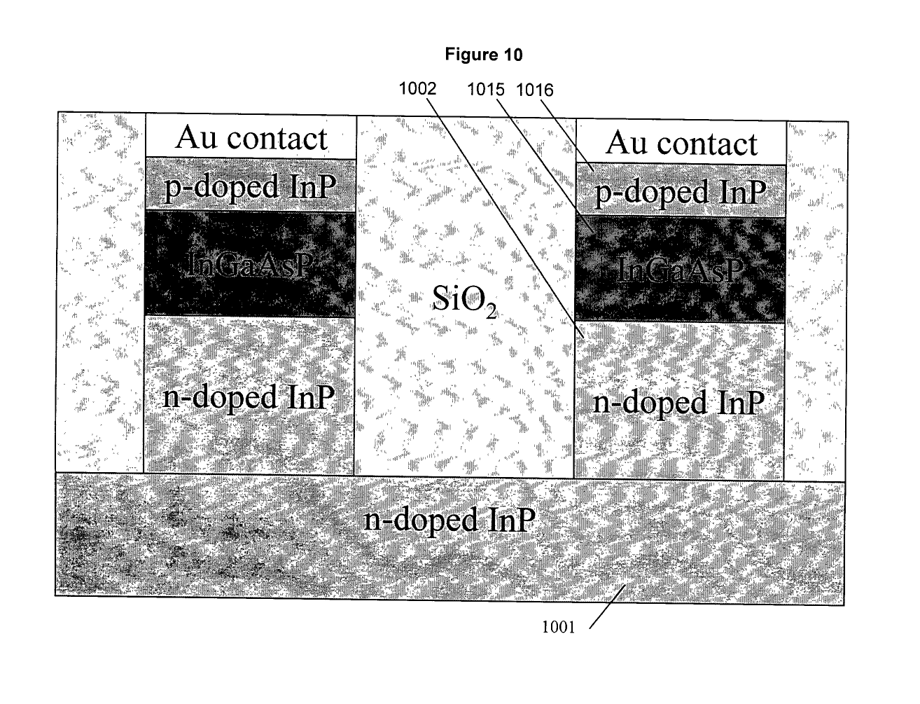

The ridge embodiment will now be described with reference to FIGS. 8-10, these figures being analogous to FIGS. 2-4 which depict the buried heterostructure embodiment. In the ridge waveguide embodiment of the invention, the following physical specifications are utilized, it being understood that such values are exemplary, and numerous other dimensionalities are possible. The size of the chip is approximately 250 μm×250 μm. The cross sections of the input waveguide 110, the tunable ring resonator 130 and the output absorbing waveguide 120, with reference to FIG. 1, are shown in FIGS. 8, 9 and 10, respectively. In the ridge embodiment, all three sections are integrated on a common n-doped InP-semiconductor substrate 801, 901 and 1001 (see FIGS. 8-10). The width of each waveguide 110,120 and 130 (with reference to FIG. 1) is 1.6 microns. The average radius of curvature, R, of the ring is 150 microns, chosen to ensure a Free Spectral Range (“FSR”) of 100 GHz. As noted above, if a smaller FSR is desired, as may be necessary in the future to support a DWDM system with a smaller channel spacing, i.e. a smaller inter service wavelength distance, the radius of curvature would need to be increased. As noted above, in general, the FSR is inversely proportional to the radius of the resonant ring 130. The air gap between the input waveguide 110 and the curved sections of the resonant ring 130 at the point of closest approach, depicted as W in FIG. 1, is 0.1 microns. The layer heights for the ridge sections of each of the three waveguide sections are as follows: n-doped InP 802, 902,1002: 1.5 microns; InGaAsP core 815,915, 1015: 0.45 microns; p-doped InP 816, 1016: 0.25 microns. In the output waveguide, shown in FIG. 9 the additional InGaAs absorption layer 917 is 0.08 microns, and the p-doped InP 916 is 0.17 microns. Thus the height of the ridge sections of each of the input, output and ring waveguides in this embodiment, not including the metal contacts in the ring, is thus 2.2 microns. It is noted that in each of FIGS. 4 and 10, which depict the ring structure in cross section, the drawing is not to scale in the horizontal dimension. Thus the two waveguide sections shown are actually separated by the diameter of the ring, or 2R. Had the drawings been to scale in the horizontal dimension, the two rings could not be depicted on the same page.

Device Operation

It is noted in both embodiments (i.e., that of the buried heterostructure —FIGS. 2-4—and that of the ridge structure—FIGS. 8-10) of the ring resonator, that the donut shaped Au contact on top of the ring is for the tuning current. The straight waveguide Au contact on the output waveguide is for the photocurrent—the detected signal.

The operation of the device is as follows. The DWDM signal is coupled into the input waveguide 110. The evanescent tail of the guided electric field overlaps the ring in the region of closest approach. Most of the light passes the ring unperturbed, but a small portion couples into the ring. As the light makes many revolutions around the ring, only the wavelength which meets the resonance condition persists. On the other side of the ring, the light circulating in the ring is partially coupled into the absorbing output waveguide 120. This light is seen as a photocurrent. The ring resonator can be designed such that the 3 dB spectral width of the photodetector response for any given tuning condition is 1 GHz. The tuning current changes the effective index of the guided mode in this region. Consequently, the spectrum of out-coupled light is shifted in the direction of refractive index change. This change in the cavity resonance can be observed in the wavelength spectrum of the photo response in the detection junction. In a preferred embodiment the bandwidth of the filter is less than 1 GHz.

The present invention is superior to other systems utilizing only linear waveguides, as opposed to rings, for the following reasons. In the linear grating implementation, the one waveguide has to be used for two purposes: tuning and absorbtion. That design compromises one function in order to accommodate the other.

The tuning electrode should cover as much of the cavity as possible, yet is is forced to yield space to the absorber, in the grating embodiment. The consequence is that the tuning currents, and thus power requirements, need to be higher. On the other hand, in the ring implementation, the tuning electrode covers 100% of the cavity.

Also, in either implementation, one may want to apply a bias voltage to the absorption region. In the grating implementation, it is hard to control the voltage of the absorption region independently from the voltage of the tuning region because the one region merges into the other. In the ring implementation, the tuning ring and the absorbing straight ouput waveguide are distinct, and thus electrically isolated.

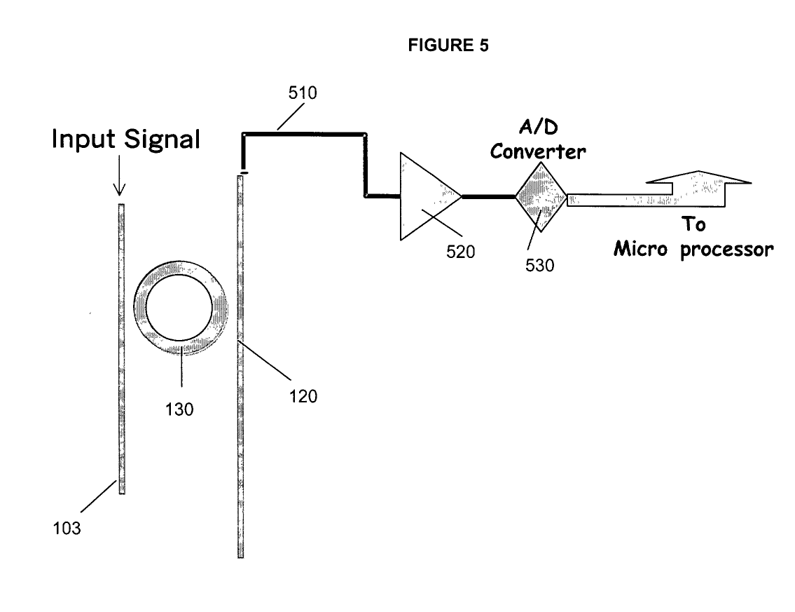

The performance monitor signal can be generated from the photocurrent using an exemplary scheme as shown in FIG. 5. The optical power in the 0.01 nm slice of the input spectrum is directly proportional to the photocurrent 550 generated in the absorption section of the device. The photocurrent 550 is amplified using a trans-impedance amplifier 560 which converts the photocurrent into a voltage. This voltage is digitized by the A/D converter 570, and read using a micro-controller (not shown in FIG. 5). The micro-controller outputs the corresponding tuning current values to obtain the optical spectrum of the incoming signal.

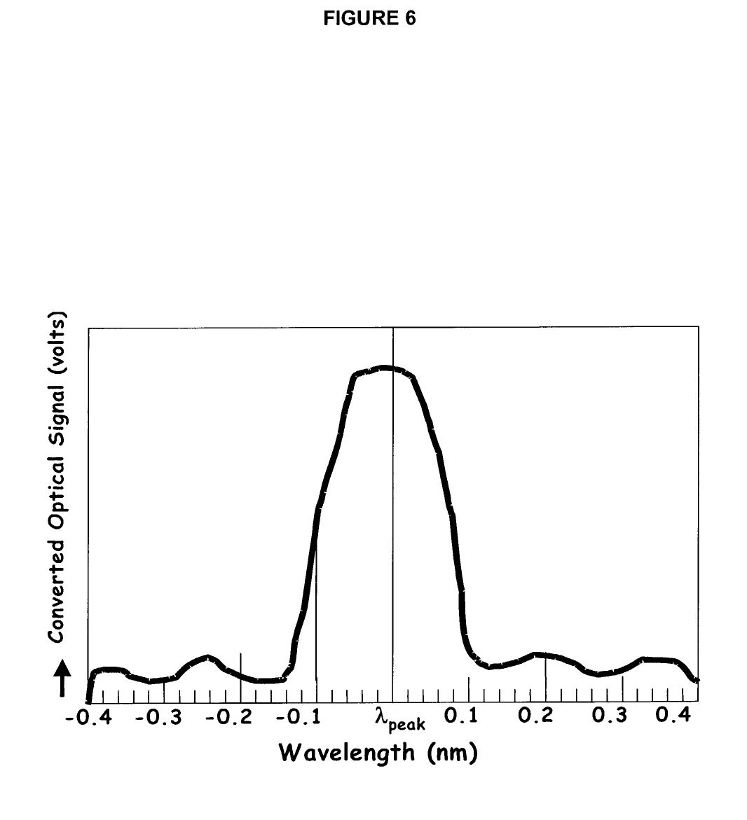

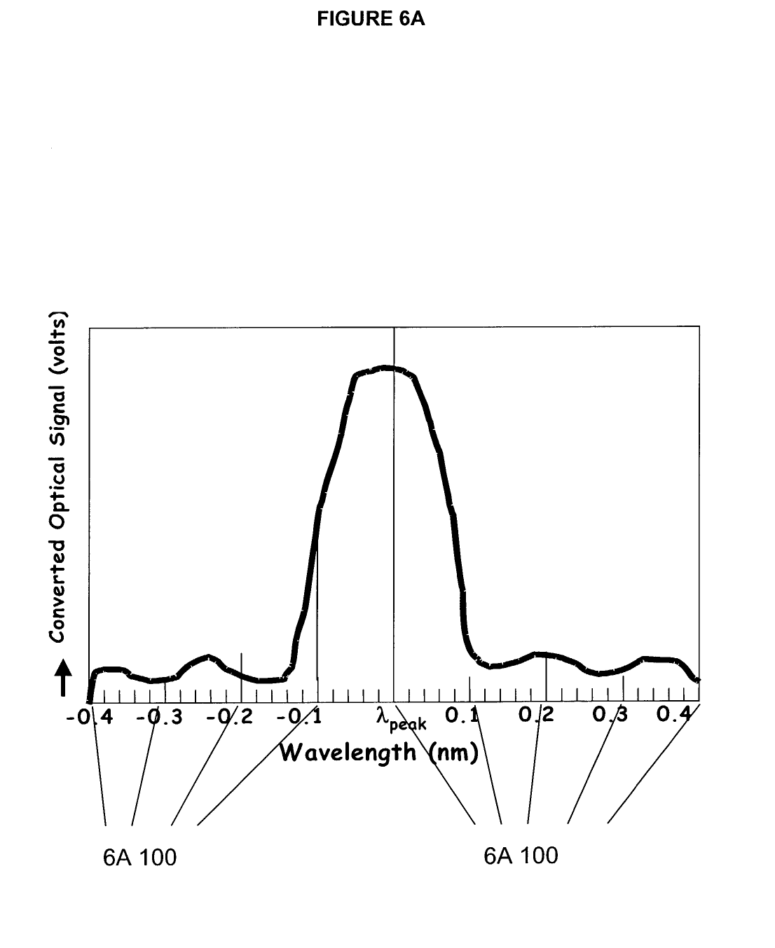

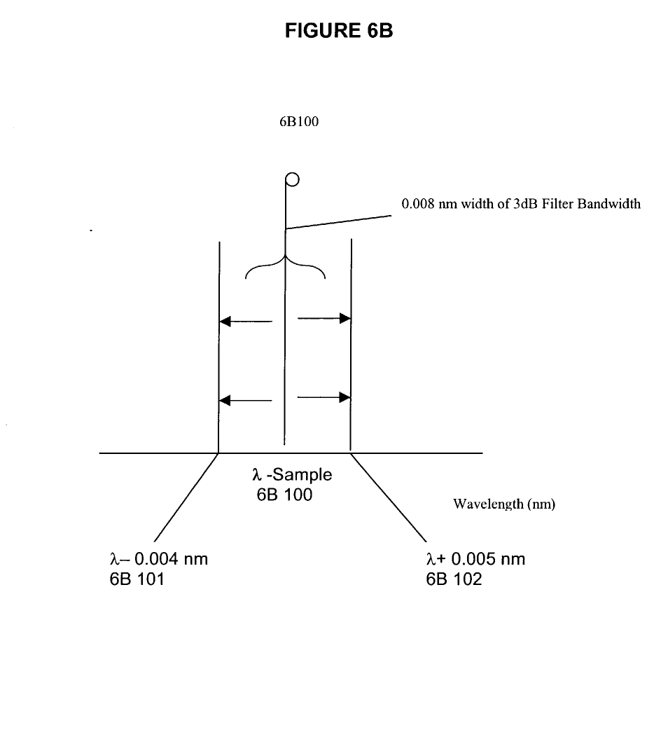

The OSNR is measured by measuring the optical spectrum of the DWDM signal of a signal of multiple channels. A schematic diagram of an exemplary measured optical spectrum is shown in FIG. 6.

FIG. 6 depicts an example measurement to find the signal strength and power at a certain wavelength λ serviced in the optical network. The range to be measured is the desired wavelength +/−0.4 nm. 9 sample points of the spectrum at 0.1 nm intervals are used to measure the OSNR when the DWDM spectral separation is 100 GHz. The various 9 sample points 6A100 in such an exemplary measurement are depicted in FIG. 6A, where the samples are taken centered at each of the spectral points A+/−(N)(0.1) nm, where N={4,3,2,1,0}.

Assume, for example, that the optical network utilizes the “C” band of frequencies, or those frequencies near 1550 nm. It is noted that for frequencies near 1550 nm a 100 GHz distance in the frequency domain translates to an 0.8 nm distance in wavelength. Thus, with a spectral separation of 100 GHz between carrier frequencies, the wavelength separation between any two carrier wavelengths in the “C” band will be 0.8 nm. Sweeping the wavelengths from λ-0.4 nm through λ+0.4 nm will thus measure the optical signal throughout the range of any given service (or other) wavelength, λ.

FIG. 6B shows the swath of wavelength of any 1 sample of the plurality of samples taken. Since the 3 dB filter bandwidth is 0.008 nm, a given sample of a wavelength λ-sample 6B 100 measures the signal parameters in the swath of wavelength from A-0.004 6B 101 through λ+0.004 6B 102. The Lambda-sample wavelengths can be chosen by any variety of convenient methods as may be appropriate. One system may find an equidistant periodic sampling through the λ-0.4 nm through λ+0.4 nm spectrum, as depicted in FIG. 6A advantageous. Other non equidistant sample spacings (such as more samples closer to λ-sample and fewer farther away) may be advantageous in other situations.

The value of the OSNR from these measurements is given by the following formula:

$$OSNR = \frac{{V}_{peak}}{\sum {V}_{non \text{-} peak}}$$

The value Vₚₑₐₖ gives the optical power in the signal channel.

The tuning of the refractive index in the tuning section is based upon the injection of charge in the form of the tuning current. Consequently, the tuning process is very fast. A single channel trace can be obtained very easily with 25 scans operating at a data rate of 1 MHz. This implies that reliable spectral measurement can be carried out in approximately 0.225 msec. (25 scans multiplied by 9 samples multiplied by 1 microsecond per sample; 225 microseconds or 0.225 msec.). Thus, the device provides a very compact means for rapidly measuring the OP and OSNR of an individual DWDM signal channel.

Obviously, in alternative embodiments, the samples could be taken at smaller or larger wavelength intervals, as may be desired to optimize system monitoring. As well, in other embodiments of the invention, the value of the OSNR can be taken using the average Vnon-peak, written as V′ₙₒₙ₋ₚₑₐₖ in the denominator (as opposed to the aggregate Vnon-peak), calculated as follows:

$$OSNR = \frac{{V}_{peak}}{{{V}^{′}}_{non \text{-} peak}}$$

Where V′ₙₒₙ₋ₚₑₐₖ=(Σ Vₙₒₙ₋ₚₑₐₖ/number of non-peak samples taken).

Determination of the number of samples to be taken, the wavelength intervals at which such samples are centered, as well as the algorithm for calculating the OSNR from these measurements, can be determined by the user, as specific conditions may dictate to facilitate optimization of signals in a given network.

It is assumed that the optical input signal to the device is a signal channel signal in a DWDM system. This signal is obtainable from the mixed DWDM signal by means of a variety of filters, or coarse tuning devices, as is well known in the art. Thus such devices have not been described herein.

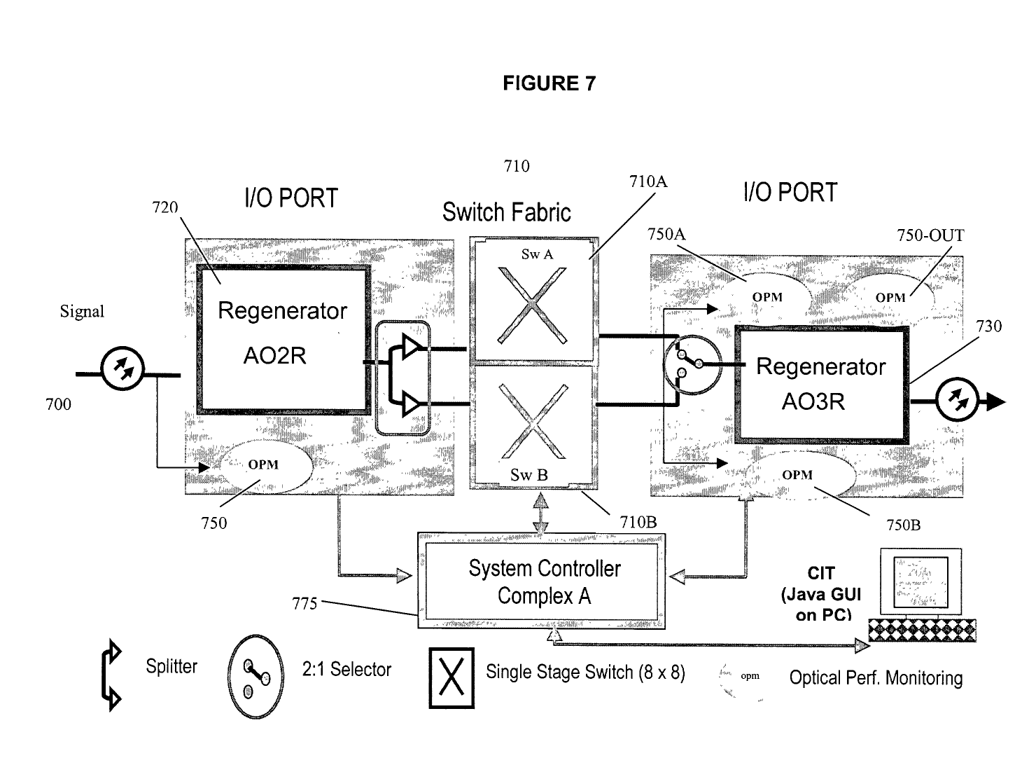

FIG. 7 depicts an exemplary deployment of the device and method of the invention. The device is used at various points in the optical signal path of an optical communications system. What is shown is the switching functionality of such an optical communications system. The system accomplishes regeneration and reshaping at the input side of the switch fabric 710, and regeneration, reshaping and retiming at the output side of the switch fabric 710. The switch fabric has two redundant switches 710A and 710B, to insure fail safe operation. To properly monitor the input signal 700, the incoming signal 700 is monitored as to performance by an OPM 750. As well, at the output of each switch the signal output from that switch is additionally monitored by OPMs 750A and 750B. The switch with the best signal output is used, or alternatively, a default switch is used until the signal performance output from it drops below certain defined thresholds.

The chosen signal is fed through the 3R regenerator 730, and the signal output from the 3R regenerator 730 is again monitored by OPM 750 OUT. The measurements of the various OPMs described are fed to the system control 775 (the connections to the system controller are not shown in FIG. 7) for real time decision making.

Using the method and apparatus of the present invention, a higher resolution method of monitoring signal strength and quality in optical networks emerges. The emerging all optical data network does not employ any O-E-O, or Optical to Electrical to Optical conversion whatsoever. Thus, the data only exists as modulations of an optical carrier signal. Large numbers of these individual signals are multiplexed for transmission between network nodes, such as in the now ubiquitous DWDM method (multiplexing 40, 80, and even larger numbers of individual carrier wavelengths). Therefore, in order to adequately monitor signal strength and OSNR, it is imply not sufficient to monitor that of the mixed, or multiplexed signal, but rather each and every single channel signal must be monitored as well. This can be now accomplished in a quick and expeditious manner.

Where simultaneous measurements of the signal power and OSNR are necessitated, a parallel array of the devices of the present invention, equal to the number of single DWDM channels in the system, can be utilized. Where sufficient time exists to not require absolute simultaneous monitoring of all of the incoming signals, either the device of the present invention can be successively fed different wavelength signals, or, using the natural middle ground combining parallel and series topographies, an array with a number of devices less than the total number of DWDM wavelengths can each be input a number of single channel signals successively.

Applicants' invention has been described above in terms of specific embodiments. It will be readily appreciated by one of ordinary skill in the art, however, that the invention is not limited to those embodiments, and that, in fact, the principles of the invention may be embodied and practiced in other devices and methods. Therefore, the invention should not be regarded as delimited by those specific embodiments but by the following claims.

What is claimed is:

1. A semiconductor device comprising:
an optical input waveguide for accepting a wavelength multiplexed optical signal of multiple wavelengths;
a ring resonator coupled with said input waveguide, said ring resonator having a tunable resonance cavity for selecting an optical signal at a predetermined single wavelength; and
an optical output absorbing waveguide coupled with said ring resonator for generating an output signal corresponding to said selected signal at said predetermined wavelength.

2. The device of claim 1 wherein both said input waveguide and output waveguide are straight in shape.

3. The device of claim 2 wherein said input waveguide and said out waveguide are arranged at opposite sides of said ring resonator.

4. The device of claim 1 wherein said tunable ring resonator has a 3 dB width of 1 GHz.

5. The device of claim 1 wherein said ring resonator comprises means for tuning said resonance cavity by changing an current injected into said ring.

6. The device of claim 1 wherein said device is integrated in a single optical circuit on a common substrate.

7. The device of claim 1, where the output waveguide further comprises an absorbing region.

8. A system for monitoring a wavelength multiplexed optical signal, comprising:
means for demultiplexing said multiplexed signal into demultiplexed signals of each wavelength;
means for measuring optical performance of said demultiplexed signals.

9. The system of claim 8 wherein said means for demultiplexing comprises a semiconductor device.

10. The system of claim 9 wherein said semiconductor comprises an input waveguide for accepting said multiplexed signal, a ring resonator coupled with said input waveguide having a tunable resonant cavity for selecting an optical signal at a predetermined wavelength, and an output waveguide coupled with said ring resonator for generating an output signal corresponding to said selected signal at said specific wavelength.

11. The system of claim 10 wherein said resonant cavity is tunable by changing a current injected into said ring resonant.

12. The system of claim 11 wherein said means for demultiplexing comprises an array of demultiplexing devices, each of which generating a demultiplexed signal of a predetermined wavelength.

13. The system of claim 12 wherein each of said demultiplexing device comprises an input waveguide for accepting said multiplexed signal, a selecting element for selecting an optical signal at a specific wavelength, and an output waveguide coupled for generating an output signal corresponding to said selected signal at said specific wavelength.

14. The system of claim 13 wherein said selecting element is a ring resonator
coupled with said input waveguide and with said output waveguide.

15. The system of claim 14 wherein said ring resonator is tunable as to its resonant cavity.

16. The system of claim 15 wherein said resonant cavity is tunable by changing an current injected into said ring resonator.

16. A system for measuring the optical power and optical signal to noise ratio of optical signals in a data network, comprising:
a photodetector;
a trans-impedance amplifier;
an analog to digital converter; and
a microprocessor.

17. The system of claim 16, where the photodetector is the device of any of claims 1-7.

18. The system of claim 17, where the photodetector, trans-impedance amplifier, and analog to digital converter are integrated in one circuit on a common substrate.
